(19) United States
(12) Patent Application Publication
(10) Pub. No.: US 2026/0017539 A1
(43) Pub. Date: Jan. 15, 2026

(54) PERSONALIZED AI ACTION GRAPH GENERATION MODEL BASED AI INFERENCE DEVICE

(71) Applicant: BLOCKCHAIN LABS INC., Seoul (KR)

(72) Inventors: Yongtae KIM, Seoul (KR); Byungwan LIM, Seoul (KR); Jonghoon PARK, Hanam-si (KR); Byeongcheol YOO, Seoul (KR)

(73) Assignee: BLOCKCHAIN LABS INC., Seoul (KR)

(21) Appl. No.: 18/779,899

(22) Filed: Jul. 22, 2024

(30) Foreign Application Priority Data
Jul. 10, 2024 (KR) 10-2024-0090806

(51) Int. Cl. G06N 5/04

(52) U.S. Cl. CPC G06N 5/04

(57) ABSTRACT

The present disclosure relates to a personalized AI inference device having at least one processor. The processor receives a query from a user, obtains user characteristic information, and generates an action graph including a plurality of nodes and a plurality of edges between the plurality of nodes. A node of the plurality of nodes corresponds to a function defined to be executable by a computer. An edge of the plurality of edges represents a data flow between connected nodes. A value of incoming edge of the node is input data of the function. A value of outgoing edge of the node is output data of the function. The action graph is a directed acyclic graph. The processor outputs a response to the query by executing the functions included in the generated action graph in an order defined by the generated action graph.

### CROSS-REFERENCE TO RELATED APPLICATION

This application claims priority to Korean Patent Application No. 10-2024-0090806 filed on Jul. 10, 2024, and all the benefits accruing therefrom under 35 U.S.C. § 119, the contents of which are incorporated by reference in their entirety.

### BACKGROUND

Embodiments disclosed herein relate to large language models and generative AI technology.

A large language model (hereinafter, LLM) is an artificial intelligence model trained on vast amounts of text data, providing highly relevant natural language outputs in response to natural language inputs. LLMs learn language structure, context, semantic patterns, and general knowledge, which they use to generate responses to user inputs. By learning extensive text data on various topics and situations, LLMs can provide appropriate and informative answers to all human questions or situations. Additionally, LLMs can provide information across multiple fields and respond quickly and accurately to users' diverse needs.

### SUMMARY

The training method of LLMs focuses on modeling a wide range of general language usage rather than learning based on individual data or preferences of specific users. Furthermore, LLMs are not designed to remember continuous interactions with users, and each session is conducted independently. Therefore, existing LLMs are limited in generating personalized responses based on users' personal information or past interactions.

On the other hand, the Retrieval-Augmented Generation (RAG) model is designed to complement the limitations of LLMs, enabling answers to questions that require up-to-date information or specialized knowledge unknown to LLMs. When a user's query is given, RAG performs a search in a pre-indexed large-scale database for information related to the query, finding information or documents highly relevant to the question. It then works in conjunction with existing LLMs to generate responses based on the retrieved information.

RAG can be utilized to implement LLMs that provide personalized responses to users. For example, documents containing user's personal information can be pre-vectorized to build a database, and when processing user queries, the vector database can be searched to find documents (or phrases within documents) most relevant to the user query, which can be used in composing the response. However, even with this method, it merely refers to related documents found through similarity measurement with the user query, resulting in less sophisticated responses, and still has limitations in providing personalized responses based on real-time data associated with the user.

Various embodiments disclosed in this document aim to provide a personalized AI inference device that can implement various actions capable of acquiring user's personal information, generate and execute an action graph based on these actions, thereby providing personalized responses.

In accordance with an exemplary embodiment of the present invention, a personalized AI inference device, the personalized AI inference device comprising at least one processor, wherein the at least one processor is configured to receive a query from a user, obtain user characteristic information associated with the user, generate, based on the query and the user characteristic information, an action graph including a plurality of nodes and a plurality of edges between the plurality of nodes, wherein a node included in the plurality of nodes corresponds to a function defined to be executable by a computer, wherein an edge included in the plurality of edges represents a data flow between connected nodes, wherein a value of incoming edge of the node is input data of the function, wherein a value of outgoing edge of the node is output data of the function, and wherein the action graph is a directed acyclic graph, and output a response to the query by executing the functions included in the generated action graph in an order defined by the generated action graph.

### BRIEF DESCRIPTION OF THE DRAWINGS

Exemplary embodiments can be understood in more detail from the following description taken in conjunction with the accompanying drawings, in which:

FIG. 1 is a diagram explaining the operational overview of a personalized AI inference device according to an embodiment.

FIG. 2 is a diagram explaining the block diagram and operational environment of a personalized AI inference device according to an embodiment.

FIG. 3 is a diagram explaining the deep learning model of an AI action graph generator according to an embodiment.

FIG. 4 is an example of an action graph according to an embodiment.

With regard to the description of the drawings, the same or similar reference numerals may be used for the same or similar components.

### DETAILED DESCRIPTION OF EMBODIMENTS

Hereinafter, various embodiments of the present disclosure will be described with reference to the accompanying drawings. However, this is not intended to limit the present disclosure to specific embodiments, and should be understood to include various modifications, equivalents, and/or alternatives of the embodiment of the present disclosure.

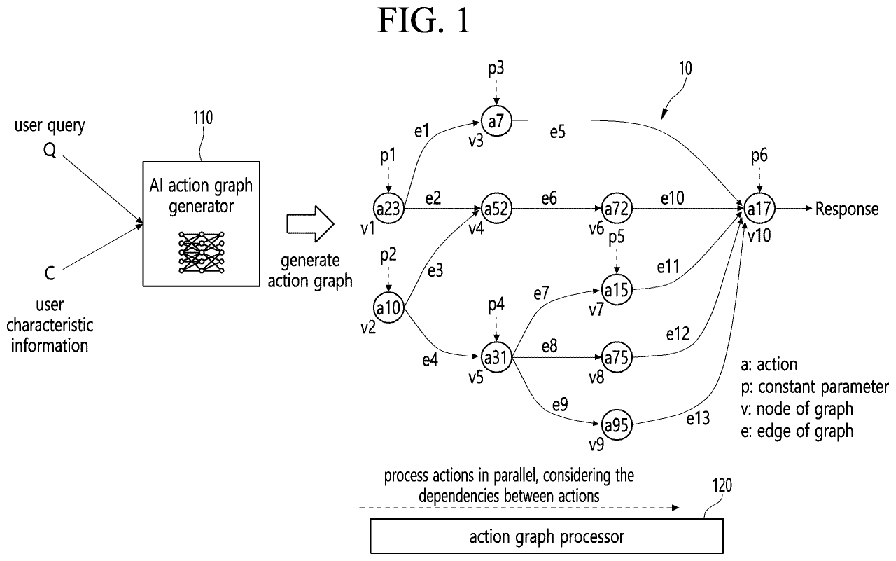

FIG. 1 is a diagram explaining the operational overview of a personalized AI inference device 100 according to an embodiment. The personalized AI inference device 100 can be understood as a device capable of receiving user queries and generating personalized responses to those user queries.

Referring to FIG. 1, the personalized AI inference device 100 may include an AI action graph generator 110 and an action graph processor 120. The AI action graph generator 110 and action graph processor 120 can be understood as modules performing the operations of the personalized AI inference device 100, and the operations of each of the AI action graph generator 110 and action graph processor 120 can be understood as operations of the personalized AI inference device 100.

The AI action graph generator 110 can generate an action graph 10 that defines the processes necessary to provide a personalized response to the received user query. The action graph 10 specifies actions that can be performed on a computer, their processing order, and data flow.

The action graph processor 120 can process the generated action graph 10 and generate a response to the user query. The action graph processor 120 can process actions in parallel, considering the dependencies between actions included in the action graph 10.

The personalized AI inference device 100 can receive a user query (Q) from a user. For example, the user can access to the personalized AI inference device 100 through a user device (not shown) and transmit a user query for which they hope to receive a response to the personalized AI inference device 100. The user query can be composed in natural language.

The received user query is delivered to the AI action graph generator 110. When the AI action graph generator 110 receives the user query, it can obtain the user characteristic information (C) of the user.

The user characteristic information can allow the AI action graph generator 110 to provide different responses reflecting individual user characteristics to the same question. The AI action graph generator 110 can generate an action graph 10 that reflects the user's characteristics for the user query based on the user characteristic information.

In various embodiments, the user characteristic information may include personality type information derived from personality tests such as MBTI, DISC, MMPI, BASC, etc. The action graph generator 110 can be implemented to generate different action graphs 10 based on the user's personality type information, even if the same user query is input.

The AI action graph generator 110 can generate an action graph 10 based on the user query and the user characteristic information. The action graph 10 can have a graph structure including multiple nodes (e.g., v1 to v10) and multiple edges (e.g., e1 to e13) between the multiple nodes.

In one embodiment, the action graph 10 may be a Directed Acyclic Graph. The action graph 10 can express the actions necessary for the personalized AI inference device 100 to process the user query and generate a response, the processing order of the actions, and the data flow. The actions can be implemented to acquire necessary information from external services (e.g., external services that have the user's personal information) to generate personalized responses. Alternatively, the actions can be implemented to infer necessary information through an external LLM model.

Actions and action graphs according to various embodiments can be defined by Equations 1 and 2. First, an action according to one embodiment can be defined as follows in Equation 1.

$$a ∈ A \\ A = \{ ( λ a , Ia , Oa ) \vert λ a ∈ Λ , Ia ∈ T , Oa ∈ T \} \\ λ a : Ia \to Oa \qquad [ Equation 1 ]$$

In Equation 1, a is an action, and A can be understood as a predefined set of actions. Each action included in the action set (A) can consist of a lambda function (λa), input data type (Ia), and output data type (Oa).

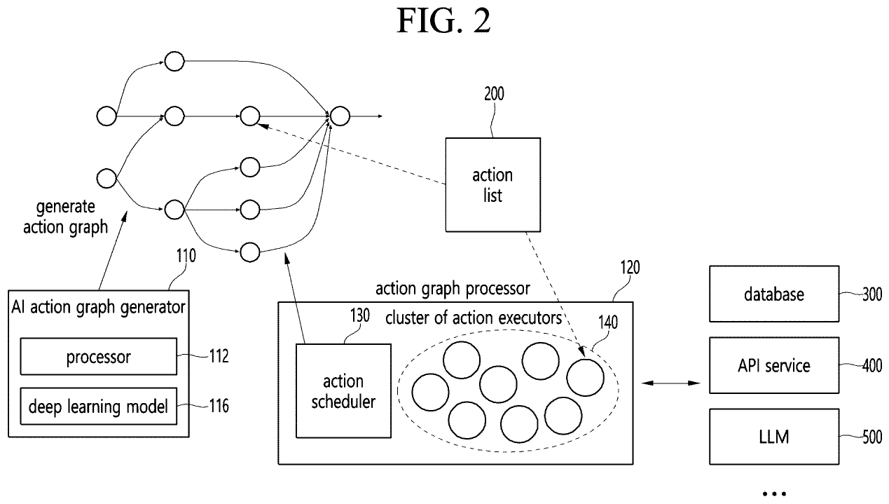

In various embodiments, the lambda function (λa) can be understood as computer-executable code that executes a function on input data of the input data type (Ia) and generates output data of the output data type (Oa). The lambda function (λa) can be implemented as a decision logic that can determine true or false result values, or it can be implemented to call other AI models such as LLM (e.g., LLM 500 in FIG. 2) for inference on input data. The lambda function (λa) can be implemented to call external APIs (e.g., API service 400 in FIG. 2) to acquire data from external services (e.g., user's written posts, purchase history, etc.) or to perform tasks in external services (e.g., purchasing products, making reservations, placing orders, etc.). Additionally, the lambda function (λa) can be implemented to access specific databases (e.g., database 300 in FIG. 2) to acquire necessary data, and can be implemented to perform various data processing. Meanwhile, the input data type (Ia) and output data type (Oa) can be arrays [symbol] T [symbol] (or power sets of T) of any data type T.

In one embodiment, the action graph 10 can be expressed as in Equation 2.

$$AG : ( V , E ) = ( \{ ( A , P ) \} , \{ 𝔼 \} ) \\ V = \{ ( a , p ) \vert a ∈ A , p ∈ P = T \} \qquad [ Equation 2 ]$$

E={(vfrom, vto,

$$\{ {O}_{a}^{j} \to {I}_{{a}^{′}}^{k} \} )$$

|vfrom, vto∈V,

$${O}_{a}^{j} :$$

j-th output parameter of action a of vfrom,

$${I}_{{a}^{′}}^{k} :$$

k-th input parameter of action a′ of vto,

$$\{ {O}_{a}^{j} \to {I}_{{a}^{′}}^{k} \} :$$

mapping information between input and output parameters for connected nodes}
ιa[i]: value of the i-th parameter of the input data (actual data instance) of action a
oa[i]: value of the i-th parameter of the output data (actual data instance) of action a

Referring to Equation 2, as described above, the action graph (AG) consists of a set of nodes (V) and a set of edges (E). Each node included in the set of nodes (V) can consist of an action set (A) and constant input parameters (P). The constant input parameters (P) can be understood as constant input parameters (e.g., data search conditions, keywords, etc.) determined by the AI action graph generator 110. The constant input parameters are data values associated with the user query and can be values determined by the AI action graph generator 110. The constant input parameters (P) can be arrays [symbol] T [symbol] (or power sets of T) of any data type T. The constant input parameters (P) become data input to the lambda function (λa) along with the input data (ιa).

Each edge included in the set of edges (E) exits from the starting node (vfrom) and enters the destination node (vto), and the value of the edge can be the output parameter

$$( {O}_{a}^{j} )$$

of the action (a) performed at the starting node and the input parameter

$$( {I}_{{a}^{′}}^{k} )$$

of the action (a′) to be performed at the destination node. In various embodiments, an action can have multiple input and output data pairs. For example, the j-th output parameter of action (a) can be defined as the k-th input parameter of action (a′). The edges can include mapping information (e.g., refer to Table 2 below) of input and output parameters for connected nodes (actions).

Referring back to FIG. 1, the node of the action graph 10 corresponds to a lambda function defined to be executable by a computer, and the edge of the action graph 10 can be understood as the data flow between connected nodes. The value of the edge entering the node (incoming edge) is the input data of the lambda function corresponding to that node, and the value of the edge exiting from the node (outgoing edge) is the output data of the lambda function corresponding to that node. Also, the input data of the lambda function may include at least a portion of the output data of the function corresponding to the starting node of the incoming edge, and the output data of the lambda function may include at least a portion of the input data of the function corresponding to the destination node of the outgoing edge.

The multiple nodes included in the action graph 10 may include a first node having no incoming edge and having an outgoing edge, a second node having both incoming and outgoing edges, a third node having no incoming edge and having an outgoing edge and constant input parameters, and a fourth node having incoming edges, outgoing edges, and constant input parameters.

The first node can correspond to a first lambda function that is performed without input data. The second node can correspond to a second lambda function that is performed by receiving output data from the lambda function corresponding to at least one node connected to the second node as input.

In one embodiment, when the input data of the second lambda function corresponding to the second node includes multiple input parameters, and the output data of the function corresponding to the starting node of the incoming edge of the second node consists of multiple output parameters, the incoming edge of the second node in the action graph 10 may further include mapping information indicating that the j-th output parameter among the multiple output parameters of the starting node corresponds to the k-th input parameter among the multiple input parameters of the second node.

In various embodiments, at least some nodes among the multiple nodes included in the action graph 10 may further include constant input parameters (if constant input parameters are defined in the lambda function). The constant input parameters can be included in the input data of the lambda function corresponding to these nodes. For example, if these nodes are the third node, only the constant input parameters may become the input data of a third lambda function corresponding to the third node. For example, if these nodes are the fourth node, the constant input parameters and the output data parameter of a fourth lambda function corresponding to the node connected to the incoming edge of the fourth node together may become the input data of the fourth node.

In one embodiment, when the input data of the fourth lambda function corresponding to the fourth node includes multiple input parameters, and the output data of the lambda function corresponding to the starting node of the incoming edge of the fourth node consists of multiple output parameters, the incoming edge of the fourth node in the action graph 10 may further include mapping information indicating that a j-th output parameter (or the constant input parameter) among the multiple output parameters of the starting node corresponds to a k-th input parameter among the multiple input parameters of the fourth node.

According to various embodiments, one action can be defined by a lambda function (λa), input data type (Ia), and output data type (Oa). Alternatively, one action can be defined by one node, the incoming edge of the node, and the outgoing edge of the node. If constant input parameters are defined in the lambda function, the node may further include constant input parameters.

The personalized AI inference device 100 can generate a response to the user query by executing the actions included in the generated action graph 10. The action graph processor 120 can process predefined action codes in parallel according to the dependencies between actions included in the action graph 10. The action graph processor 120 can execute all actions included in the action graph 10 and generate a final response. Once the final response is generated, it can be provided to the user as a response to the user query.

FIG. 2 is a diagram explaining the block diagram and operational environment of the personalized AI inference device 100 according to an embodiment. Referring to FIG. 2, the personalized AI inference device 100 may include an AI action graph generator 110 and an action graph processor 120. The personalized AI inference device 100 may include an action list 200. The action list 200 can be understood as a list of predefined actions, that is, a list of codes implementing the actions included in the aforementioned action set (A).

The AI action graph generator 110 can generate an action graph 10, and the action graph processor 120 can schedule and execute actions based on the generated action graph 10 and the action list 200 to generate a final response.

According to one embodiment, the AI action graph generator 110 may include a processor 112 and memory (not shown). The memory may include a deep learning model 116. The processor 112 may include multiple processors that can control the overall operation of the AI action graph generator 110. The operation of the AI action graph generator 110 can be understood as the operation of the processor 110.

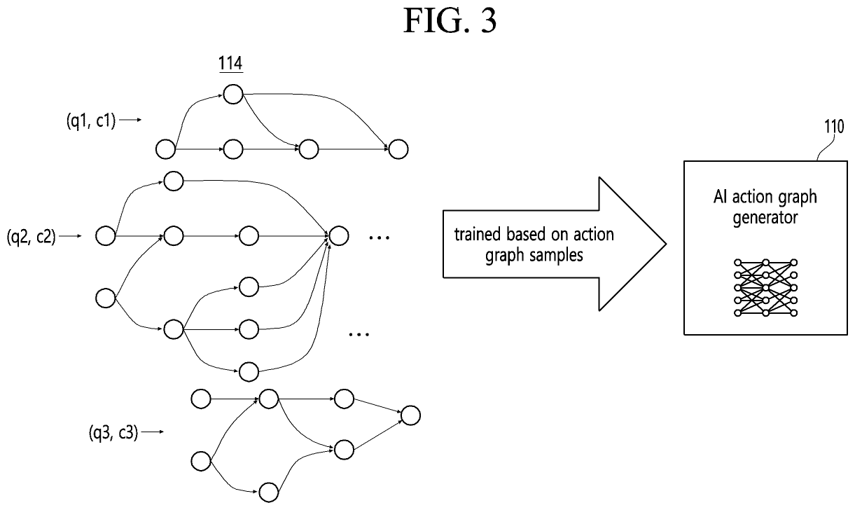

The deep learning model 116 can be understood as an artificial intelligence model that automatically generates an AI action graph 10 based on user queries and user characteristic information. The deep learning model 116 can be trained from action graph samples. An action graph sample can be understood as multiple sample data consisting of pairs of user queries, user characteristic information, and action graphs. The action graph sample may include a predetermined multiple sample data. The deep learning model 116 can be trained based on a pre-made dataset of queries, user characteristic information, and action graphs to automatically generate the action graph for new user queries and user characteristic information. The description of the deep learning model 116 is explained later through FIG. 3.

When the AI action graph generator 110 receives a user query, it can obtain the user characteristic information of the user who sent the user query, and generate an action graph 10 based on the user query and user characteristic information.

The AI action graph generator 110 can generate an action graph 10 that includes at least some of the actions included in the action list 200 based on the user query and the user characteristic information. The AI action graph generator 110 can check the dependencies between actions to be included in the action graph, determine the execution order of actions accordingly, and generate the action graph 10. The action graph generation operation of the AI action graph generator 110 can be performed automatically based on the deep learning model 116.

For example, the action graph 10 in FIG. 1 generated by the AI action graph generator 110 can be expressed as shown in Table 1.

TABLE 1

| Node Information | Edge Information |
|---|---|
| V = { | E = { |
| v1: (a23, p1), | e1:(v1, v3, |
| v2: (a10, p2), | { Oₐ₂₃¹→Iₐ₇¹ , Oₐ₂₃²→Iₐ₇² , Oₐ₂₃³→Iₐ₇⁴ } ), |
| v3: (a7, p3), | e2:(v1, v4, |
| v4: (a52, Ø), | { Oₐ₂₃²→Iₐ₅₂¹ , Oₐ₂₃³→Iₐ₅₂² } ), |
| v5: (a31, p4), | e3:(v2, v4, |
| v6: (a72, Ø), | { Oₐ₁₀³→Iₐ₅₂⁴ , Oₐ₁₀⁴→Iₐ₅₂³ } ), |
| ... | ... |
| v9: (a95, Ø), | e13:(v9, v10, { Oₐ₉₅¹→Iₐ₁₇⁵ }) |
| v10: (a17, Ø) | } |
| } | |

Also, the actions included in each node can be defined by lambda functions, input data types, and output data types, such as a23=(λa23, Ia23, Oa23), a10=(λa10, Ia10, Oa10), . . . , a17=(λa17, Ia17, Oa17).

In various embodiments, the AI action graph generator 110 may send questions to the user device to obtain information necessary to process the user query. The AI action graph generator 110 can receive answers to the questions from the user device and use those answers as user characteristic information, input data, or input parameters for actions.

According to one embodiment, the action graph processor 120 may include an action scheduler 130 and a cluster of action executors 140. The cluster of action executors 140 can be understood as multiple processing units. The action graph processor 120 can process and execute actions in parallel considering the dependencies between actions included in the action graph 10 and generate a response. The action scheduler 130 can determine which action should be performed currently and which unit of the cluster of action executors 140 will execute the action. According to the execution order of actions, currently available processing units can process the actions by the action scheduler 130.

For example, referring to the action graph 10 in FIG. 1, the action graph 10 consists of a total of 10 nodes (v1 to v10) and 13 edges (e1 to e13). Each node corresponds to a lambda function and constant input parameters, and each edge corresponds to the input-output data flow between connected nodes. For example, action52 (a52) is implemented as lambda function-action52 (λa52), takes the output data of action23 (a23) as input data, and the output data of action52 becomes the input data of action72 (a72). Also, there are no constant input parameters going into action52. Finally, the output data of action17 (a17) becomes the response to the user query.

For example, the action graph (10) can be executed by the action graph processor (120) in the following order: v1: λa23(p1[1], p1[2])→oa23, v2: λa10(p2[1], p2[2], p2[3])→oa10, v3: λa7(oa23[1], oa23[2], p3[1], oa23[3], p3[2], p3[3])→oa7, v4: λa52(oa23[2], oa23[3], oa10[4], oa10[3])→oa52, . . . , v10: λa17(oa7[2], oa72[3], oa15[1], oa75[1], oa75[1], p6[1], p6[2])→oa17, Response: oa17.

v1 and v2 are starting nodes, and action 23 of v1 and action 10 of v2 can be performed simultaneously. Action 23 of v1 requires two constant input parameters, and output data oa23 is generated. The output data oa23 becomes the input data for action 7 of v3 and action 52 of v4. Action 7 of v3, for example, can generate output data oa7 using oa23[1], oa23[2], p3[1], oa23[3], p3[2], p3[3] as input data. Action 7 takes a total of 6 input parameter values as input data. Action 7 takes the first parameter value of action 23's output data as the first input parameter, the second parameter value of action 23's output data as the second input parameter, the first value of the constant input parameter as the third input parameter, the third parameter value of action 23's output data as the fourth input parameter, the second value of the constant input parameter as the fifth input parameter, and the third value of the constant input parameter as the sixth input parameter. By performing actions from v1 to v10 in this way, the final output data oa17 becomes the final response to the user query.

In one embodiment, the personalized AI inference device 100 can acquire necessary information from external devices to generate personalized responses to user queries. External devices can be, for example, devices allowed access by external services. External devices can be understood as, for example, database 300, API service 400, and LLM 500. The personalized AI inference device 100 can acquire necessary information from these external devices through pre-implemented actions.

According to various embodiments, actions included in the action list 200 can be implemented to access the database 300, API service 400, and LLM 500, and acquire information related to user queries. The database 300, API service 400, and LLM 500 are examples of external devices, and actions can be implemented to access third-party services and devices accessible through the network to acquire necessary data.

For example, the database 300 can be understood as a database containing personal information of specific users. An action according to one embodiment can access to the database 300 and acquire personal information necessary to generate personalized responses to user queries.

For example, the API service 400 can be understood as API services provided by various external services such as SNS services, portal sites, e-commerce services, etc. An action according to one embodiment can access to the API service 400 and acquire personal information related to external services such as activity history, posts, purchase history, etc.

For example, LLM 500 can be a conversational artificial intelligence model provided by an external service. An action according to one embodiment can use LLM 500 to acquire general information related to user queries or to generate natural language responses to user queries. The action can receive text data from LLM 500.

FIG. 3 is a diagram explaining the deep learning model 116 of the AI action graph generator 110 according to an embodiment. The AI action graph generator 110 can be designed based on artificial intelligence algorithms. Action graph samples 114 can be used as training data for the artificial intelligence algorithm. The AI action graph generator 110 can be trained to generate different action graphs for the same user query based on user characteristics.

Referring to FIG. 3, for example, multiple data sets consisting of pairs of user queries (q1, q2, q3), user characteristic information (c1, c2, c3), and action graphs (AG1, AG2, AG3) are shown as an example of action graph samples 114.

In various embodiments, the initial action graph samples 114 as training data can be pre-made by humans. Also, weights for each data set included in the action graph samples 114 can be set differently. The action graph samples 114 can be updated according to the operation of the AI action graph generator 110. For example, weights for each data set included in the action graph samples 114 can be adjusted differently. Alternatively, newly generated data of user queries, user characteristic information, and action graphs by the deep learning model 116 can be added to the action graph samples 114.

The AI action graph generator 110 can learn weights that derive the correlation between user queries, user characteristic information, and action graphs based on the action graph samples 114. The trained deep learning model 116 can be stored in memory 120. Accordingly, the personalized AI inference device 100 can operate to derive new action graphs according to learned correlations for new user queries and new user characteristic information based on the deep learning model 116.

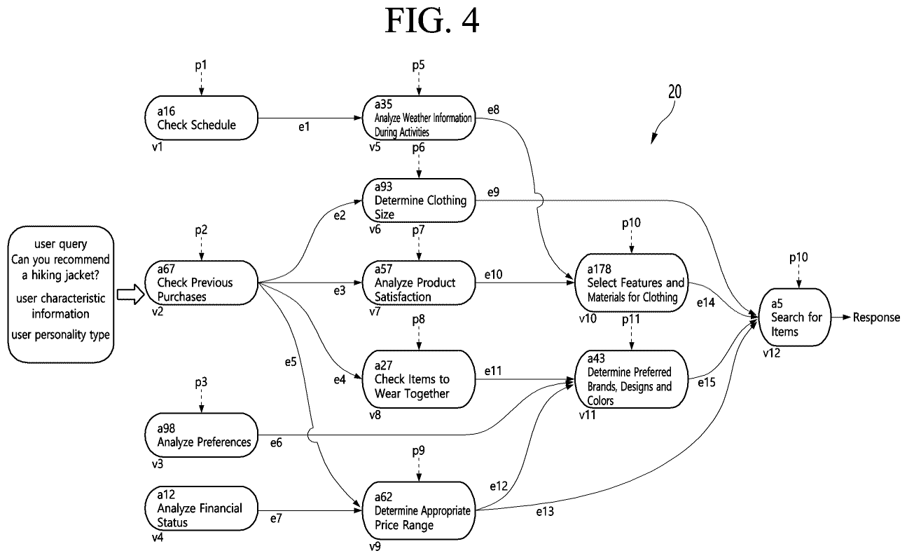

FIG. 4 is an example of an action graph 20 according to an embodiment. For example, action graph 20 can be understood as generated by the AI action graph generator 110 based on user queries and user characteristic information. In this example, the user query is ‘Can you recommend a hiking jacket?’ and the user characteristic information comprises ‘personality type information’.

The AI action graph generator 110 can generate an action graph 20 that includes actions necessary to generate a response to the user query based on the user query and user characteristic information. Referring to FIG. 4, actions 16, 67, 98, 12, 35, 93, 57, 27, 62, 178, 43, and 5 were selected. Furthermore, the action graph 20 including those actions can be composed of vertices and edges as shown in Table 2. Mapping information of input and output data between connected actions is included in the edges.

TABLE 2

| Node Information | Edge Information |
|---|---|
| v1: (a16, p1) | e1:(v1, v5, { Oₐ₁₆³→Iₐ₃₅² }) |
| v2: (a67, p2) | e2:(v2, v6, { Oₐ₆₇→Iₐ₉₃² }) |
| v3: (a98, p3) | e3:(v2, v7, { Oₐ₆₇³→Iₐ₅₇² }) |
| ... | ... |
| v12:(a5, p10) | e15:(v11, v12, { Oₐ₄₃¹→Iₐ₅⁵, |
| | Oₐ₄₃²→Iₐ₅⁶, Oₐ₄₃¹→Iₐ₅⁷ }) |

Also, actions included in each node can be defined as a16(λa16, Ia16, Oa16), a67(λa67, Ia67, Oa67), . . . , a5(a5(λa5, Ia5, Oa5).

The action graph 20 can be executed in the following order: V1: λa16(P1[1])→oa16, V2: λa67(P2[1])→oa67, V3: λa98(P3[1], P3[2])→oa98, V4: λa12(Ø)→oa12, . . . , V12: λa12(P12[1], oa93[1], oa62[1], oa178[1], oa43[1], oa43[2], oa43[3])→oa5, Response: oa5.

For example, the lambda function (λa16) of action 16 (a16) is a function for checking schedules, and the input data type (Ia16) is activity type, where the actual input parameter could be ‘P1[1]=hiking’ as a constant input parameter. The output data type (Oa16) of the lambda function (λa16) is schedule information, and the actual output parameter (oa16) could be ‘oa16[1]: Cheonggye Mountain 12 times in the past, oa16[2]: Bukhan Mountain 13 times in the past, oa16[3]: Seorak Mountain next week’. And the third output parameter of the lambda function (λa16) (oa16[3]: Seorak Mountain next week) becomes the second input parameter of the lambda function (λa35) of action 35. This mapping information ({Oₐ₁₆_{³}→Iₐ₃₅_{²}}) is included in edge e1. Since the lambda function (λa35) is a function for weather analysis during activities, it can output weather information based on the schedule information derived from the lambda function (λa16).

According to various embodiments, actions can be implemented to access to the aforementioned database 300, API service 400, and LLM 500 and acquire necessary information.

For example, in action graph 20, actions 16 and 98 can be implemented to access the database 300 storing the user's personal information and acquire information to generate output data.

Action 67 can be implemented to acquire a list of purchased clothing items using the API service 400 provided by the shopping service (e.g., Amazon, Coupang) used by the user.

Action 12 can be implemented to acquire ‘income, consumption, asset status, credit card loan status’ using the API service 400 provided by the financial service (e.g., bank, credit card company) used by the user.

Action 35 can be implemented to acquire weather information for the scheduled event (‘Seorak Mountain next week’) using the API service 400 provided by the weather service based on the output data of action 16.

Actions 93, 57, 27, 62, 178, and 43 can be implemented to infer output data using LLM 500 based on defined parameters and input data. For example, actions 93, 57, and 27 can be implemented to generate output data using LLM 500 based on the ‘list of purchased clothing items’ output from action 67. For instance, actions 93, 57, and 27 can send prompts to LLM 500 requesting analysis of clothing sizes, product satisfaction, and matched items for the ‘list of purchased clothing items’, receive analysis results from LLM 500, and generate output data based on the analysis results.

Action 5 can acquire a list of recommended hiking jackets using the API service 400 provided by the shopping service (e.g., Amazon, Coupang) used by the user based on defined parameters and input data.

In one embodiment, the action scheduler 130 of the action graph processor 120 can select an action to be executed considering the dependencies between the aforementioned actions and the dependencies between the paths, and assign available units in the action executor cluster 140 to the action.

According to one example, when v12-action 5, the last node of action graph 20, is completed, the response can be generated as follows:

Since you hike frequently (action 16), it would be good to have a comfortable and durable product (action 62, 57, 178). You have a hike scheduled at Seoraksan next week(action 16), and it might rain, so I looked for products made of waterproof Gore-Tex material(action 35, 178). Considering your usual interests (action 98, 43) in Arc'tery and Columbia products and environmentally friendly Patagonia products(action 67, 57, 27, 43), and your current financial situation(action 12) I selected reasonably priced(action 62) options: 1. Arc'teryx Beta LT Jacket(Large)—Men's, 2. Columbia Ibex Il Jacket(Medium)—Men's, 3. Patagonia Torrentshell 3L Jacket(Large)—Men's (action 5, 93).

The response can include information acquired from each action. Accordingly, a personalized response can be provided. Referring to the above example, the action that is the source of the information is indicated in parentheses.

The computing device according to the various embodiments disclosed in this document can be various types of devices. The computing device may include, for example, a portable communication device (e.g., smartphone), a computer device, a portable multimedia device, a wearable device, or a home appliance. The computing device according to the embodiments of this document is not limited to the aforementioned devices.

Various embodiments of this document and terms used therein are not intended to limit the technical features described in this document to specific embodiments, and should be understood to include various modifications, equivalents, or alternatives of the embodiments. In relation to the description of the drawings, similar reference numerals may be used for similar or related components. The singular form of a noun corresponding to an item may include one item or a plurality of items, unless the relevant context clearly dictates otherwise. In this document, each of phrases such as “A or B”, “at least one of A and B”, “at least one of A or B”, “A, B or C”, “at least one of A, B and C”, and “at least one of A, B, or C” may include all possible combinations of items listed together in the corresponding phrase among those phrases. Terms such as “first”, “second”, “firstly”, or “secondly” may simply be used to distinguish a corresponding component from other corresponding components, and do not limit the corresponding components in other respects (e.g., importance or order). In this document, if a certain (e.g., first) element is referred to as being “connected” or “coupled” with or without the terms “functionally” or “communicatively” to another (e.g., second) component, it means that the certain component can be connected to the other component directly (e.g., in a wired manner), wirelessly, or through a third component.

Various embodiments described in this document can be implemented as software (e.g., programs) including one or more instructions stored in a machine-readable storage medium (e.g., internal memory or external memory) that can be read by a device (e.g., personalized AI inference device 100). For example, the processor (e.g., action graph processor 120, processor 112) of the device (e.g., personalized AI inference device 100, AI action graph generator 110) can call at least one instruction from the one or more instructions stored in the storage medium and execute it. This enables the device to operate to perform at least one function according to the called at least one instruction. The one or more instructions may include code generated by a compiler or code that can be executed by an interpreter. The machine-readable storage medium can be provided in the form of a non-transitory storage medium. Here, ‘non-transitory’ means only that the storage medium is a tangible device and does not include signals (e.g., electromagnetic waves), and this term does not distinguish between cases where data is stored semi-permanently on the storage medium and cases where it is stored temporarily.

According to various embodiments, each component (e.g., module or program) of the components described above may include one or a plurality of entities. According to various embodiments, one or more components among the components described above or operations may be omitted, or one or more other components or operations may be added. Alternatively or additionally, a plurality of components (e.g., modules or programs) may be integrated into one component. In this case, the integrated component may perform one or more functions of each component of the plurality of components identically or similarly to those functions performed by a corresponding component among the plurality of components prior to the integration. According to various embodiments, operations performed by modules, programs, or other components may be executed sequentially, in parallel, iteratively, or heuristically, or one or more of the operations may be executed in a different order or omitted, or, one or more other operations may be added.

According to the embodiments disclosed in this document, personalized responses considering the user's personal information can be provided to users utilizing conversational AL. In addition, various effects that can be directly or indirectly identified through this document may be provided.

What is claimed is:

1. A personalized AI inference device comprising:
at least one processor;
wherein the at least one processor is configured to:
receive a query from a user,
obtain user characteristic information associated with the user,
generate, based on the query and the user characteristic information, an action graph including a plurality of nodes and a plurality of edges between the plurality of nodes, wherein a node included in the plurality of nodes corresponds to a function defined to be executable by a computer, wherein an edge included in the plurality of edges represents a data flow between connected nodes, wherein a value of incoming edge of the node is input data of the function, wherein a value of outgoing edge of the node is output data of the function, and wherein the action graph is a directed acyclic graph, and
output a response to the query by executing the functions included in the generated action graph in an order defined by the generated action graph.

2. The personalized AI inference device of claim 1, wherein the input data of the function includes at least a portion of the output data of the function corresponding to a starting node of the incoming edge, and
wherein the output data of the function includes at least a portion of the input data of the function corresponding to the node that is a destination node of the outgoing edge.

3. The personalized AI inference device of claim 2, wherein at least some nodes of the plurality of nodes further include a constant input parameter, and
wherein the constant input parameter is included in the input data of the function corresponding to the at least some nodes.

4. The personalized AI inference device of claim 2,
wherein, when the output data of the function corresponding to the starting node of the incoming edge includes the plurality of output parameters and the input data of the function corresponding to the node includes the plurality of input parameters,
the incoming edge further includes mapping information indicating that a j-th output parameter of the plurality of output parameters corresponds to a k-th input parameter of the plurality of input parameters.

5. The personalized AI inference device of claim 1, wherein the function is configured to generate the output data based on data obtained through at least one of a database, a large language model, and an API service.

6. The personalized AI inference device of claim 1, wherein the user characteristic information includes personality type information of the user.

7. The personalized AI inference device of claim 1, further comprising a deep learning model,
wherein the deep learning model is trained based on a pre-made dataset of queries, user characteristic information, and action graphs to automatically generate the action graph for the query and the user characteristic information.
